(19) United States
(12) Patent Application Publication
(10) Pub. No.: US 2016/0235191 A1
(43) Pub. Date: Aug. 18, 2016

(54) One in one dental floss toothbrush

(71) Applicant: Charles Ray Trent, Forrest City, AR (US)

(72) Inventor: Charles Ray Trent, Forrest City, AR (US)

(21) Appl. No.: 14/756,743

(22) Filed: Jan. 27, 2016

(51) Int. Cl. A46B 15/00; A61C 15/04; A61C 15/02

(52) U.S. Cl. CPC A46B 15/0071; A61C 15/02; A61C 15/043; A46B 15/0069

(57) ABSTRACT

A toothbrush having a first end and a second end with a plurality of picks in removeable communication with the second end, and a floss cutter configured to cut dental floss. The toothbrush has a body with a first side and a second side, the body comprising a hollow interior, wherein at least at least one plastic stud is configured to engage at least one sleeve, wherein dental floss is wrapped around the at least one sleeve. The dental floss extends from the at least one sleeve through the floss cutter, wherein the body and wherein the first end and the second end are in communication with the first side of the body.

### BACKGROUND OF THE INVENTION

1. Field of Invention

The present invention relates to the field of dental hygiene and more specifically toothbrushes and flossing devices.

2. Description of Related Art

Personal hygiene includes a daily routine including cleaning and preparation of various body areas. Dental care is one of the most important aspects of the personal hygiene routine, which includes brushing teeth and flossing. The majority of people, if they do take the time to brush their teeth, neglect to floss because of the additional time necessary.

Current toothbrushes will have a brush end and may lack any specific component for flossing, or may have a simple pick that is incapable of properly flossing between teeth.

Based on the foregoing, there is a need in the art for a convenient and cost effective device that would allow a user to brush and floss their teeth without having to purchase separate devices or taking unnecessary time to use two or more different devices. A need for a device that will promote better dental hygiene practices for dental care.

### SUMMARY OF THE INVENTION

The purpose of my invention and design is to provide a one (1) in one (1) toothbrush that will meet the demands of today's fast pace world and offer a better and more effective way for dental care. My invention has a tracking system made inside of a toothbrush that pulls floss from the end of the toothbrush which allows the user to pull as much floss as needed. Plus there are four (4) picks on each corner of the toothbrush. My invention has a tracking system made inside of a toothbrush handle it enables the user to pull as much floss from the end of the toothbrush as needed and has a cutter at the end of the tooth brush to sever the floss when flossing is completed, there are also four (4) picks on each corner of the toothbrush which has a cap that covers the back end of my toothbrush.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the 1 in 1 toothbrush flosser, according to an embodiment of the present invention;

FIG. 2 is a perspective view of the 1 in 1 toothbrush flosser, according to an embodiment of the present invention;

FIG. 3 is a perspective view of the 1 in 1 toothbrush flosser, according to an embodiment of the present invention;

FIG. 4 is a side elevation view of the 1 in 1 toothbrush flosser, according to an embodiment of the present invention.

FIG. 5 is a plan view of the 1 in 1 toothbrush flosser, according to an embodiment of the present invention;

### DETAILED DESCRIPTION OF PREFERRED EMBODIMENTS

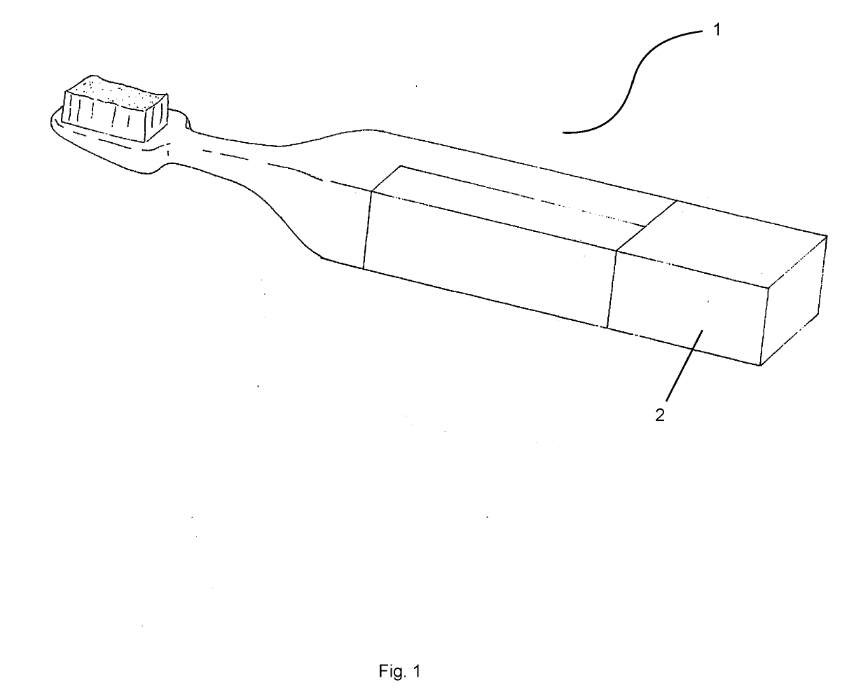

Preferred embodiments of the present invention and their advantages may be understood by referring to FIGS. 1-5, wherein like reference numerals refer to like elements.

In an embodiment, the tracking system is small enough to fit into the middle of a toothbrush that provides a flosser at the end of the toothbrush. This design functions with a tracking system comprising dental floss that can be rotated by pulling as needed allowing the floss to renew itself to the flosser.

In another embodiment, the tracking system is encased in the middle of the toothbrush handle so that it doesn't visually appear different than any regular toothbrush now being sold in the marketplace. The tracking system is encased in a water proof casing that has rubber seals where the floss leaves the toothbrush handle. There is a tracking system that allows the floss to move forward as it's pulled for use.

In an embodiment, a user brushes their teeth, as well as floss before or after each brushing. This combination of a brush and dental flosser is possible by a tracking system that is sealed into the handle of the toothbrush which operates and controls the use of the dental floss.

My invention is a toothbrush with a built in flosser. It allows you to pull much as needed that releases to pull floss in place. There's built in tracking system that allows the user to pull out as much as needed. There's a built in cutting system at the tip of the device that cuts and removes the floss to be discarded with a small amount of pressure. My invention is an oral hygiene product that is designed to provide a multi purpose dental hygiene product that can be used to brush and floss teeth without having to change instruments. To prevent injury and contamination I've designed one cap that lock into grooves over each end. Its purpose is so the desired end of the device can be used without disturbing the other or cause damage to the device unknowingly. It has four toothpicks so you can pick food out of teeth. These four toothpicks are made in each corner in the back of the toothbrush.

In an embodiment, FIG. 1 shows the toothbrush 1 and floss device (not shown) as a whole, assembled unit with end cap 2 in place to protect exposed floss and toothpicks.

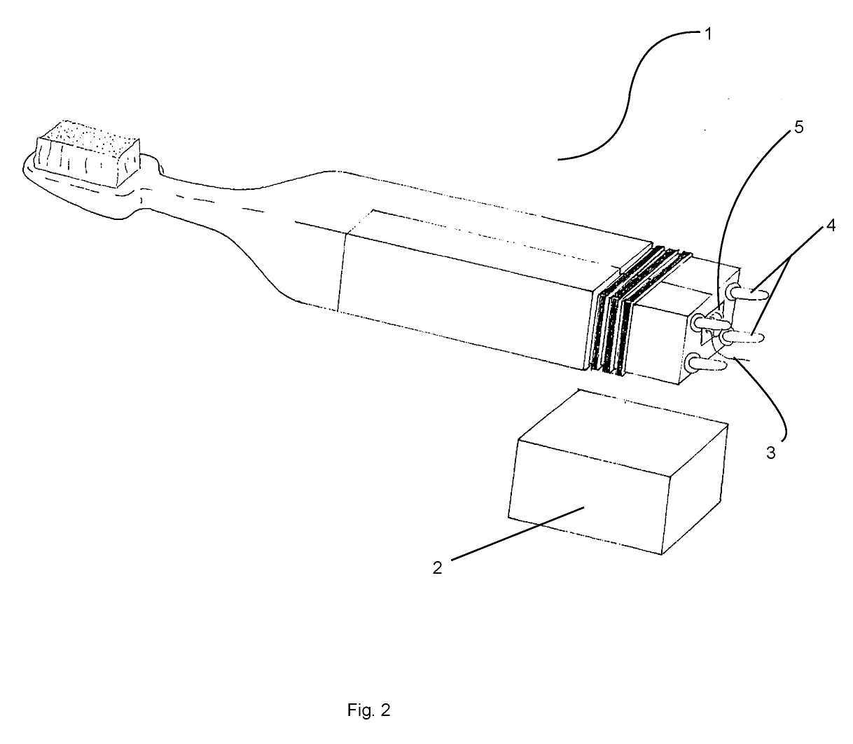

In an embodiment, FIG. 2 shows the toothbrush 1 and floss device as a whole assembled unit with end cap 2 removed exposing floss 3 and toothpicks. Shown are toothpick end handles 4 dental floss cutter device 5 end cap 2 for toothbrush to cover and protect floss 3 and toothpicks.

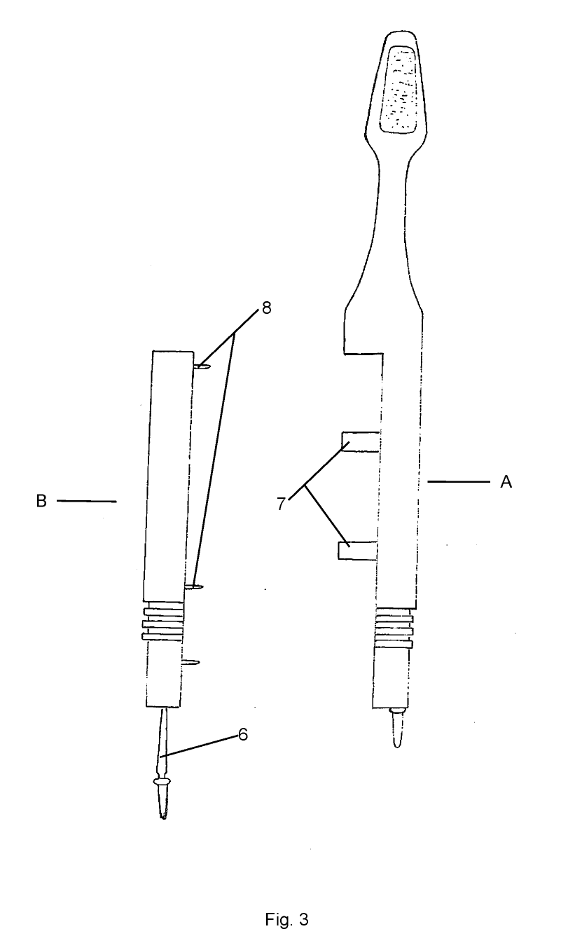

In an embodiment, FIG. 3 shows toothbrush and floss device shown from a top view disassembled into its main parts side A and side B with toothpicks 6, plastic rods 7 for dental floss placement, and male studs 8 for device assembly.

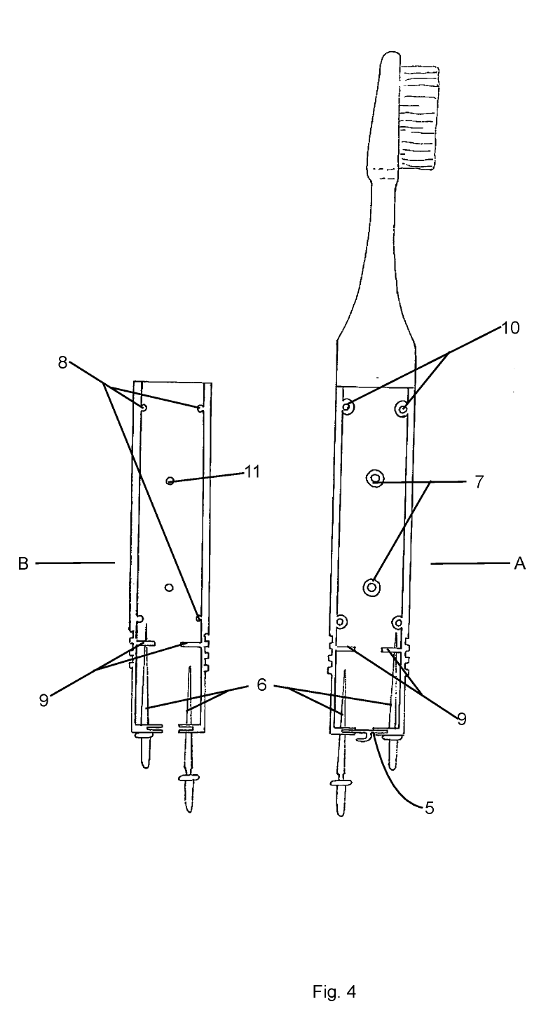

In an embodiment, FIG. 4 shows the toothbrush disassembled with its two halves side A and Side B giving view from a side angle. Shown are toothpicks 6, toothpick resting guide 9 when toothpick is inside the device, floss cutting device 5, female assembly slots 10 rods 7 for floss placement with female assembly slots on ends, male assembly studs 8, and male assembly studs 11 for floss placement rods 7.

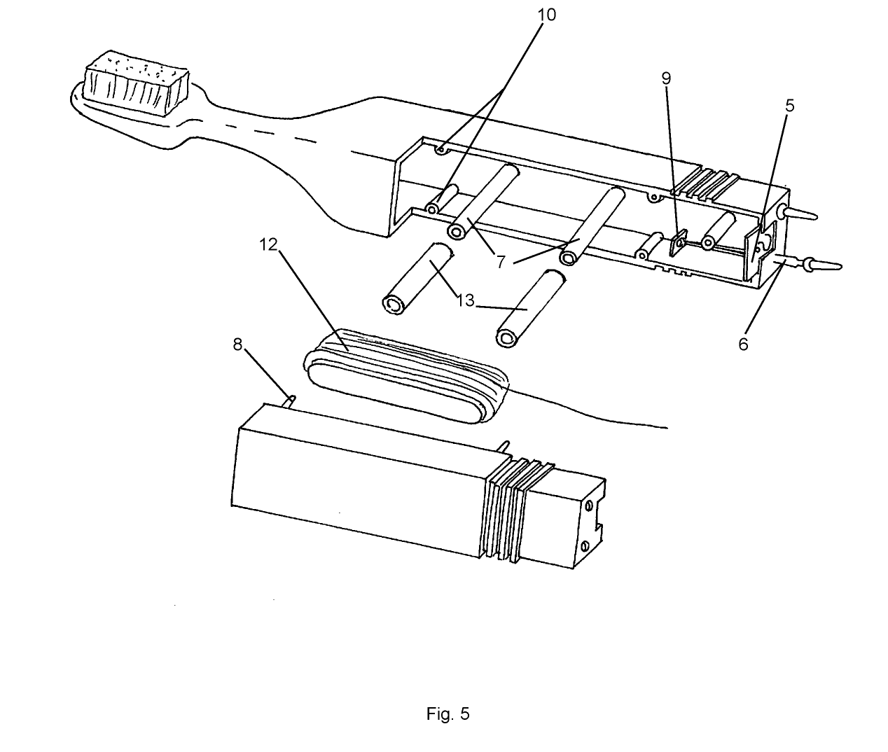

In an embodiment, FIG. 5 illustrates toothpicks 6; toothpick resting guide 9; dental floss cutter device 5; female slots 10 needed for assembly to hold the device together; plastic studs 7 to slide dental floss over to allow floss 12 to be pulled out of device and to be able to roll smoothly over; dental floss 12; Flexible plastic sleeve 13 dental floss 12 is wrapped around and which is then slipped over the plastic studs 7 to which it slide around as floss 12 is pulled out of device. Male stud ends 8 which snap into the female slots 10 for assembly and to hold device together.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A toothbrush comprising:
a. a first end having a brush;
b. a second end comprising:
i. a plurality of picks in removeable communication with the second end;
ii. and a floss cutter configured to cut dental floss;
c. a body having a first side and a second side, the body comprising a hollow interior, wherein at least at least one plastic stud is configured to engage at least one sleeve, wherein dental floss is wrapped around the at least one sleeve,
wherein dental floss extends from the at least one sleeve through the floss cutter,
wherein the body, and wherein the first end and the second end are in communication with the first side of the body.

2. The toothbrush of claim 1, further comprising a second end cap configured to releasably engage the second end.

3. The toothbrush of claim 1, wherein the first side of the body further comprises a plurality of slots and the second side of the body further comprises a plurality of studs, wherein the plurality of studs are configured to matingly engage the plurality of slots.
